(19) United States
(12) Patent Application Publication
(10) Pub. No.: US 2013/0323452 A1
(43) Pub. Date: Dec. 5, 2013

(54) Self-adhering cover for temporarily and incrementally concealing a tattoo

(71) Applicants: Leonard Jay Wiessner, Crestline, CA (US); Niki Rene Wiessner, Crestline, CA (US); Richard Scott Sandmark, Apple Valley, CA (US); Robin Rene Sandmark, Apple Valley, CA (US)

(72) Inventors: Leonard Jay Wiessner, Crestline, CA (US); Niki Rene Wiessner, Crestline, CA (US); Richard Scott Sandmark, Apple Valley, CA (US); Robin Rene Sandmark, Apple Valley, CA (US)

(21) Appl. No.: 13/507,046

(22) Filed: May 31, 2012

(51) Int. Cl. B41M 3/12; B44F 9/00; B44C 1/165

(52) U.S. Cl. 428/41.8; 428/343; 428/354; 428/207

(57) ABSTRACT

A self-adhering cover for temporarily and incrementally concealing a tattoo, while matching tone of skin of a user. The self-adhering cover includes a plurality of stacked layers. The plurality of stacked layers are for adhering to the skin of the user over the tattoo, and in so doing, temporarily and incrementally conceal the tattoo, while matching the tone of the skin of the user so as to allow the self-adhering cover to be relatively invisible.

### 1. BACKGROUND OF THE INVENTION

A. Field of the Invention

The embodiments of the present invention relate to a tattoo cover, and more particularly, the embodiments of the present invention relate to a self-adhering cover for temporarily and incrementally concealing a tattoo.

B. Description of the Prior Art

Referring now to the figures, in which like numerals indicate like parts, and particularly to FIG. 1, which is a diagrammatic side elevational view of a prior art tattoo on a user, a tattoo 10 is on skin 11 of a user 12.

Many companies are requiring their employees to keep their tattoos covered while on duty although there are make-up kits, clothing tapes, and bandages for this purpose, they have shortcomings. Also, the use of temporary tattoos¹ to cover tattoos without any special layers allows the tattoo to be visible through the cover. ¹“Temporary tattoos” are defined as “Tattoos that are usually used on children for fun. Examples can be found on web sites like http://www.tattoosales.com and http://www-temporarytattoos.com.

Thus, there exists a need for a way to cover permanent tattoos temporarily with a product that is, among other things, comfortable, safe, easy to use, won't smear or rub off, is easy to remove when needed, doesn't irritate the skin, and doesn't allow the tattoo or its shadow to show therethrough.

Numerous innovations for tattoo-related devices have been provided in the prior art, which will be described below in chronological order to show advancement in the art. Even though these innovations may be suitable for the specific individual purposes to which they address, however, they differ from the embodiments of the present invention in that they do not teach a self-adhering cover for temporarily and incrementally concealing a tattoo.

### (1) U.S. Pat. No. 6,074,721 to Moore et al.

U.S. Pat. No. 6,074,721—issued to Moore et al. on Jun. 13, 2000 in U.S. class 428 and subclass 42.1—teaches a temporary decal including a porous paper base coated with a water-soluble slip layer, e.g., dextrin gum, on which offset printing inks are directly imprinted using a high speed lithographic press. The inks are printed in a designated area only, and in a desired image. A clear spot coating, preferably, of an aqueous material, is then printed over the image area only. A contact adhesive is then spot printed over the image area of each decal, preferably, using a silk screen press. A removable cover sheet, such as a silicone-coated sheet, is placed over the contact adhesive of each printed sheet of decals to keep the sheets from sticking together. The spot coating acts as a protective layer that keeps the contact adhesive from migrating to the surface of the decal after the finished temporary tattoo is applied to the skin. Without the spot coating, the surface of the decal would become sticky to the touch and the decal would come off faster because of friction with the surrounding environment.

### (2) United States Patent Application Publication Number 2002/0110672 to Muratore-Pallatino et al.

United States Patent Application Publication Number 2002/0110672—published to Muratore-Pallatino et al. on Aug. 15, 2002 in U.S. class 428 and subclass 195—teaches a temporary opaque tattoo for concealing veins, blemishes, wine marks, bruises, age marks, and other skin conditions, which includes a transfer patch to match skin tone and pigment holding an image of human skin. The image is transferred from the patch to the skin, thereby providing an opaque cover-up. An image of human skin in varying tones is provided to closely match and blend in with a variety of skin pigments and colorings. The tattoo may be of varying sizes and shapes to cover a particular skin imperfection. The tattoo may be embedded or coated with medication to provide a tattoo that both conceals and medicates a skin condition.

### (3) U.S. Pat. No. 7,517,571 to Funke et al.

U.S. Pat. No. 7,517,571—issued to Funke et al. on Apr. 14, 2009 in U.S. class 428 and subclass 40.1—teaches a temporary tattoo for concealing and for blocking a permanent tattoo or other imperfections on an individual's skin, which includes a white opaque neutralizer base that effectively prevents read through of the underlying marking. The temporary tattoo includes at least one pigmented layer disposed on top of the white opaque neutralized base, which is intended to meter the individual's skin tone and/or pigment. The temporary tattoo also includes one or more reintroduction layers disposed between the neutralized base and the at least are pigmented layer.

### (4) United States Patent Application Publication Number 2011/0303344 to Bortel et al.

United States Patent Application Publication Number 2011/0303344—published to Bortel et al. on Dec. 15, 2011 in U.S. class 156 and subclass 64—teaches temporary tattoo removal devices for temporarily covering and concealing tattoos, which includes an opaque tattoo removal device or a releasable coating layer that is configured to adhere to a user's skin to cover and conceal tattoos. The color of the opaque tattoo removal device or releasable coating layer matches the skin tone of the user's so that the tattoo removal device or releasable coating layer is nearly invisible when applied.

It is apparent that numerous innovations for tattoo-related devices have been provided in the prior art, which are adapted to be used. Furthermore, even though these innovations may be suitable for the specific individual purposes to which they address, however, they would not be suitable for the purposes of the present invention as heretofore described, namely, a self-adhering cover for temporarily and incrementally concealing a tattoo.

### 2. SUMMARY OF THE INVENTION

Thus, it is an object of the embodiments of the present invention to provide a self-adhering cover for temporarily and incrementally concealing a tattoo, which avoids the disadvantages of the prior art.

Briefly stated, another object of the embodiments of the present invention is to provide a self-adhering cover for temporarily and incrementally concealing a tattoo, while matching tone of skin of a user. The self-adhering cover includes a plurality of stacked layers. The plurality of stacked layers are for adhering to the skin of the user over the tattoo, and in so doing, temporarily and incrementally conceal the tattoo, while matching the tone of the skin of the user so as to allow the self-adhering cover to be relatively invisible.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying drawings.

### 3. BRIEF DESCRIPTION OF THE FIGURES OF THE DRAWING

The figures of the drawing are briefly described as follows:

FIG. 1 is a diagrammatic side elevational view of a prior art tattoo on a user;

FIG. 2 is a diagrammatic side elevational view of the self-adhering cover of the embodiments of the present invention temporarily and incrementally concealing a tattoo; and

FIG. 3 is an enlarged diagrammatic cross sectional view taken along LINE 3-3 in FIG. 2.

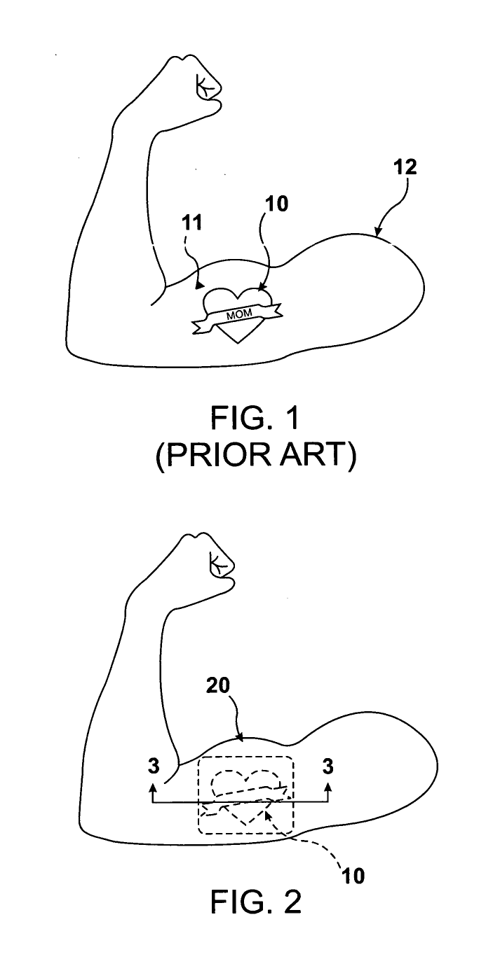

### 4. LIST OF REFERENCE NUMERALS UTILIZED IN THE FIGURES OF THE DRAWING

A. Prior Art.
10 tattoo on skin 11 of user 12
11 skin of user 12
12 user

B. Introductory.
20 self-adhering cover of embodiments of present invention for temporarily and incrementally concealing tattoo 10, while matching tone of skin 11 of user 12

C. Configuration of Self-Adhering Cover 20.
22 plurality of stacked layers for adhering to skin 11 of user 12 over tattoo 10, and in so doing, temporarily and incrementally conceal tattoo 10, while matching tone of skin 11 of user 12 so as to allow self-adhering cover 20 to be relatively invisible 24 initial blocking layer of plurality of stacked layers 22 for affixing to skin 11 of user 12 over tattoo 10 so as to provide initial increment of concealment of tattoo 10
26 initial adhesive layer of plurality of stacked layers 22 for adhering initial blocking layer 24 of plurality of stacked layers 22 to skin 11 of the user 12 over tattoo 10 so as to provide initial increment of concealment of tattoo 10
28 release sheet of plurality of stacked layers 22
30 final blocking layer of plurality of stacked layers 22 for being in tone of skin 11 of user 12 so as to provide final increment of concealment of tattoo 10 and allow self-adhering cover 20 to be relatively invisible
32 final adhesive layer of plurality of stacked layers 22
34 skin pigment graphic layer of final blocking layer 30 of plurality of stacked layers
36 contrast dispersion layer of initial blocking layer 24 of plurality of stacked layers 22

### 5. DETAILED DESCRIPTION OF THE PREFERRED EMBODIMENTS

A. Introductory.

Referring now to FIG. 2, which is a diagrammatic side elevational view of the self-adhering cover of the embodiments of the present invention temporarily and incrementally concealing a tattoo, the self-adhering cover of the embodiments of the present invention is shown generally at 20 for temporarily and incrementally concealing the tattoo 10, while matching tone of the skin 11 of the user 12.

B. Configuration of the Self-Aadhering Cover 20.

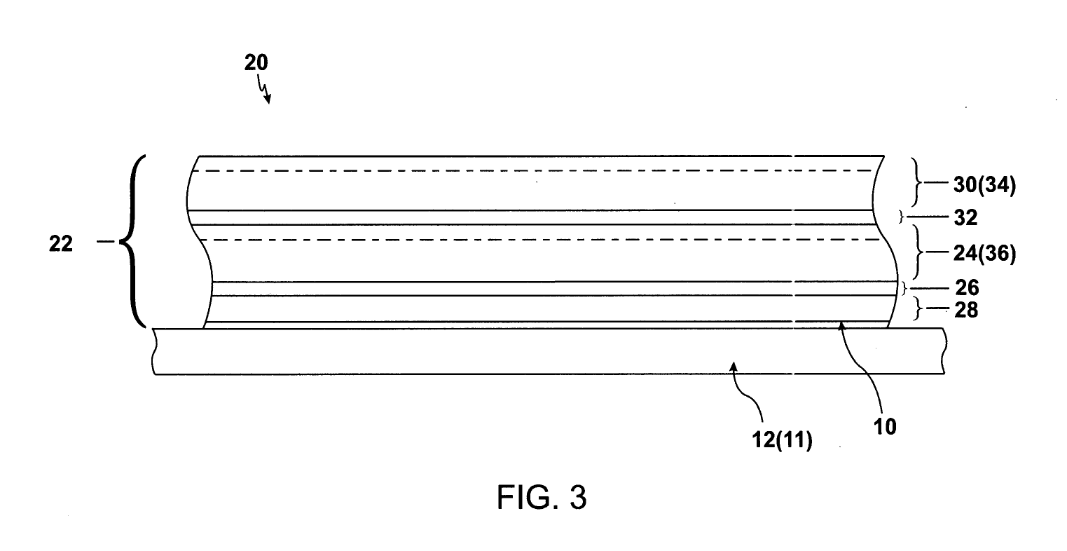

The configuration of the self-adhering cover 20 can best be seen in FIG. 3, which is an enlarged diagrammatic cross sectional view taken along LINE 3-3 in FIG. 2, and as such, will be discussed with reference thereto.

The self-adhering cover 20 comprises a plurality of stacked layers 22. The plurality of stacked layers 22 are for adhering to the skin 11 of the user 12 over the tattoo 10, and in so doing, temporarily and incrementally conceal the tattoo 10, while matching the tone of the skin 11 of the user 12 so as to allow the self-adhering cover 20 to be relatively invisible.

The plurality of stacked layers 22 comprise an initial blocking layer 24. The initial blocking layer 24 of the plurality of stacked layers 22 is for affixing to the skin 11 of the user 12 over the tattoo 10 so as to provide an initial increment of concealment of the tattoo 10.

The plurality of stacked layers 22 further comprise an initial adhesive layer 26. The initial adhesive layer 26 of the plurality of stacked layers 22 is disposed on, and below, the initial blocking layer 24 of the plurality of stacked layers 22, and is for adhering the initial blocking layer 24 of the plurality of stacked layers 22 to the skin 11 of the user 12 over the tattoo 10 so as to provide the initial increment of concealment of the tattoo 10.

The plurality of stacked layers 22 further comprise a release sheet 28. The release sheet 28 of the plurality of stacked layers 22 protects the initial adhesive layer 26 of the plurality of stacked layers 22 prior to use.

The plurality of stacked layers 22 further comprise a final blocking layer 30. The final blocking layer 30 of the plurality of stacked layers 22 is disposed on, and above, the initial blocking layer 24 of the plurality of stacked layers 22, and is for being in the tone of the skin 11 of the user 12 so as to provide a final increment of concealment of the tattoo 10 and allow the self-adhering cover 20 to be relatively invisible.

The plurality of stacked layers 22 further comprise a final adhesive layer 32. The final adhesive layer 32 of the plurality of stacked layers 22 is disposed on, and below, the final blocking layer 30 of the plurality of stacked layers 22, and adheres the final blocking layer 30 of the plurality of stacked layers 22 to the initial blocking layer 24 of the plurality of stacked layers 22 so as to provide the final increment of concealment of the tattoo 10.

The final blocking layer 30 of the plurality of stacked layers 22 is a skin pigment graphic layer 34. The skin pigment graphic layer 34 of the final blocking layer 30 of the plurality of stacked layers 22 is a top layer of ink that is a graphic (picture file) of a skin color to match a particular range of skin tones, and is the layer that is visible once the self-adhering cover 20 is applied to the skin 11 of the user 12.

The initial blocking layer 24 of the plurality of stacked layers 22 is a contrast dispersion layer 36. The contrast dispersion layer 36 of the initial blocking layer 24 of the plurality of stacked layers 22 is a layer in a temporary tattoo cover² that is under the skin pigment graphic layer 34 of the final blocking layer 30 of the plurality of stacked layers 22. ²“Temporary tattoo cover” is defined as “The use of a temporary tattoo to cover a permanent tattoo or other skin blemish, such as a birthmark or scar.

The contrast dispersion layer 36 of the initial blocking layer 24 of the plurality of stacked layers 22 is prepared by using a screen press—which up until this time had only been used to apply adhesive not for applying inks—instead of a 4 color (CMYK) lithograph printer in a temporary tattoo to give better coverage when used as a temporary tattoo cover.

The following table depicts the ingredients of the contrast dispersion layer 36 of the initial blocking layer 24 of the plurality of stacked layers 22:

| CHEMICAL NAME | % BY WEIGHT |
|---|---|
| Acrylates Copolymer | 65 |
| Alkyd Polyester Resin | 4 |
| Mineral Oil (Paraffinum Liquidum) | 4 |
| Petrolalum | 4 |
| Phenolic Modified Gloss Varnish | 4 |
| Cerium Carboxylate | 0.065 |
| Manganese 2-Ethylhexanoate | 0.03 |
| Blue 1 (Cl 42090) | 4.73 |
| Red 7 (Cl 15850:1) | 4.45 |
| Black 2 (Cl 77266) | 3.9 |
| Yellow 5 (Cl 19140) | 2.29 |
| Yellow 6 (Cl 15985) | 2.29 |
| Titanium Dioxide (Cl 77891) | 1.245 |

C. Impressions.

It will be understood that each of the elements described above or two or more together may also find a useful application in other types of constructions differing from the types described above.

While the embodiments of the present invention have been illustrated and described as embodied in a self-adhering cover for temporarily and incrementally concealing a tattoo, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features from the standpoint of prior art fairly constitute characteristics of the generic or specific aspects of the embodiments of the present invention.

The invention claimed is:

1. A self-adhering cover for temporarily and incrementally concealing a tattoo, while matching tone of skin of a user, comprising:
a plurality of stacked layers;
wherein said plurality of stacked layers are for adhering to the skin of the user over the tattoo, and in so doing, temporarily and incrementally conceal the tattoo, while matching the tone of the skin of the user so as to allow said self-adhering cover to be relatively invisible.

2. The self-adhering cover of claim 1, wherein sad plurality of stacked layers comprise an initial blocking layer; and
wherein said initial blocking layer of said plurality of stacked layers is for affixing to the skin of the user over the tattoo so as to provide an initial increment of concealment of the tattoo.

3. The self-adhering cover of claim 2, wherein said plurality of stacked layers comprise an initial adhesive layer.

4. The self-adhering cover of claim 3, wherein said initial adhesive layer of said plurality of stacked layers is disposed on said initial blocking layer of said plurality of stacked layers;
wherein said initial adhesive layer of said plurality of stacked layers is disposed below said initial blocking layer of said plurality of stacked layers; and
wherein said initial adhesive layer of said plurality of stacked layers is for adhering said initial blocking layer of said plurality of stacked layers to the skin of the user over the tattoo so as to provide the initial increment of concealment of the tattoo.

5. The self-adhering cover of claim 3, wherein said plurality of stacked layers comprise a release sheet.

6. The self-adhering cover of claim 5, wherein said release sheet of said plurality of stacked layers protects said initial adhesive layer of said plurality of stacked layers prior to use.

7. The self-adhering cover of claim 2, wherein said plurality of stacked layers comprise a final blocking layer.

8. The self-adhering cover of claim 7, wherein said final blocking layer of said plurality of stacked layers is disposed on said initial blocking layer of said plurality of stacked layers;
wherein said final blocking layer of said plurality of stacked layers is disposed above said initial blocking layer of said plurality of stacked layers; and
wherein said final blocking layer of said plurality of stacked layers is for being in the tone of the skin of the user so as to provide a final increment of concealment of the tattoo and allow said self-adhering cover to be relatively invisible.

9. The self-adhering cover of claim 7, wherein said plurality of stacked layers comprise a final adhesive layer.

10. The self-adhering cover of claim 9, wherein said final adhesive layer of said plurality of stacked layers is disposed on said final blocking layer of said plurality of stacked layers;
wherein said final adhesive layer of said plurality of stacked layers is disposed below said final blocking layer of said plurality of stacked layers; and
wherein said final adhesive layer of said plurality of stacked layers adheres said final blocking layer of said plurality of stacked layers to said initial blocking layer of said plurality of stacked layers so as to provide the final increment of concealment of the tattoo.

11. The self-adhering cover of claim 7, wherein said final blocking layer of said plurality of stacked layers is a skin pigment graphic layer.

12. The self-adhering cover of claim 11, wherein said skin pigment graphic layer of said final blocking layer of said plurality of stacked layers is a top layer of ink that is a graphic picture file of a skin color to match a particular range of skin tones; and
wherein said skin pigment graphic layer of said final blocking layer of said plurality of stacked layers is a layer that is visible once said self-adhering cover is applied to the skin of the user.

13. The self-adhering cover of claim 11, wherein said initial blocking layer of said plurality of stacked layers is a contrast dispersion layer.

14. The self-adhering cover of claim 13, wherein said contrast dispersion layer of said initial blocking layer of said plurality of stacked layers is a layer in a temporary tattoo cover that is under said skin pigment graphic layer of said final blocking layer of said plurality of stacked layers.

15. The self-adhering cover of claim 13, wherein said contrast dispersion layer of said initial blocking layer of said plurality of stacked layers is prepared by using a screen press instead of a 4 color (CMYK) lithograph printer in a temporary tattoo to give better coverage when used as a temporary tattoo cover.

16. The self-adhering cover of claim 13, wherein said contrast dispersion layer of said initial blocking layer of said plurality of stacked layers includes 65% by weight of acrylates copolymer, 4% by weight of alkyd polyester resin, and 4% by weight of mineral oil (paraffinum liquidum).

17. The self-adhering cover of claim 16, wherein said contrast dispersion layer of said initial blocking layer of said plurality of stacked layers includes 4% by weight of petrolalum, 4% by weight of phenolic modified gloss varnish, and 0.065% by weight of cerium carboxylate.

18. The self-adhering cover of claim 17, wherein said contrast dispersion layer of said initial blocking layer of said plurality of stacked layers includes 0.03% by weight of manganese 2-ethylhexanoate, 4.73% by weight of blue 1 (Cl 42090), and 4.45% by weight of red 7 (Cl 15850:1).

19. The self-adhering cover of claim 18, wherein said contrast dispersion layer of said initial blocking layer of said plurality of stacked layers includes 3.9% by weight of black 2 (Cl 77266), 2.29% by weight of yellow 5 (Cl 19140), and 2.29% by weight of yellow 6 (Cl 15985).

20. The self-adhering cover of claim 19, wherein said contrast dispersion layer of said initial blocking layer of said plurality of stacked layers includes 1.245% by weight of titanium dioxide (Cl 77891).
